(19) United States
(12) Patent Application Publication
(10) Pub. No.: US 2011/0187032 A1
(43) Pub. Date: Aug. 4, 2011

(54) RESILIENT ELEMENT COMPRISING AN S-SHAPED ELONGATED BODY OF AN ELASTIC MATERIAL

(76) Inventor: Nils-Erik Bohman, Halmstad (SE)

(21) Appl. No.: 13/122,629

(22) PCT Filed: Oct. 5, 2009
(86) PCT No.: PCT/SE2009/051103

§ 371 Date: Apr. 5, 2011

(30) Foreign Application Priority Data
Oct. 8, 2008 (SE) 0802111-5

(51) Int. Cl. F16F 1/373

(52) U.S. Cl. 267/74

(57) ABSTRACT

A resilient element having an elongated body of an elastic material through which a rope of a corresponding elongated and flexible tension element winds undulating, wherein a spring force being generated by the body at stretching of said undulation when applying a tension force in the tension element. The body having at least one S-shaped portion with at least three essentially traverse legs, in which two adjacent legs alternately are joined with each other at one side of the elongated the body and having an opening at the other side of the elongated body, wherein the tension element is intended to be introduced through said opening and undulates alternately over and below, respectively, adjacent legs.

### TECHNICAL FIELD

The present invention refers to a resilient element comprising an elongated body of an elastic material through which a rope or a corresponding elongated and flexible tension element winds undulating, wherein a spring force being generated by said body at stretching of said undulation when applying a tension force in the tension element.

### TECHNICAL BACKGROUND

Through U.S. Pat. No. 2,878,013 or U.S. Pat. No. 3,817,507 resilient elements of the introductory described kind are previously known and being used e.g. together with ropes at towing of vehicles or at mooring of boats to admit an absorbed stretching when the rope and the resilient element being exerted to a tension force.

A disadvantage with resilient elements according known technique is that the resilient element should be threaded on the rope, which is time-consuming and often difficult when the rope, which usually is extremely stiff, should be bent into curves with small radii of the curvature and be brought through several openings in a relative thick rubber bar, in which the openings have essentially same diameter as the rope. This also imply that the resilient element must be adapted to dimension of the rope and thus that several different resilient elements are required to cover a certain interval of different ropes.

### SUMMARY OF THE INVENTION

The purpose with present invention is therefore to provide a device which solve the above mentioned problems through that the resilient element being formed such that it is not needed to be threaded on the rope, and instead may be applied at a desired position along the rope, and is designed such that a certain element can be used for ropes with different dimension.

This purpose is achieved according to the invention through that the device of the introductory described kind is characterised in that said body having at least one S-shaped portion with at least three essentially transverse legs, in which two adjacent legs alternately are joined with each other at one side of the elongated body and having an opening at the other side of the elongated body, wherein the tension element is intended to be introduced through said opening in said portion and undulates alternately over and below, respectively, adjacent legs.

In one alternately embodiment the resilient element comprising several S-shaped portions preferably designed in a row and the resilient element comprising thus an elongated body which can be arranged on desired location along the rope and in which the rope being threaded alternately from one and the other side of the body and being threaded alternately over and below adjacent legs.

### BRIEF DESCRIPTION OF THE DRAWINGS

A device according to the present invention will hereafter be described closer with reference to the appended drawings, in which:

FIG. 1 is a schematic view from above of a resilient element according to the present invention arranged on a rope,

FIG. 2 is a schematic cross-section of the resilient element according to FIG. 1,

FIG. 3 is a schematic view from above of an alternately formed resilient element according to the present invention, and

FIG. 4 is a schematic side view of the resilient element according to FIG. 3 arranged on a rope.

### DETAILED DESCRIPTION OF PREFERRED EMBODIMENTS

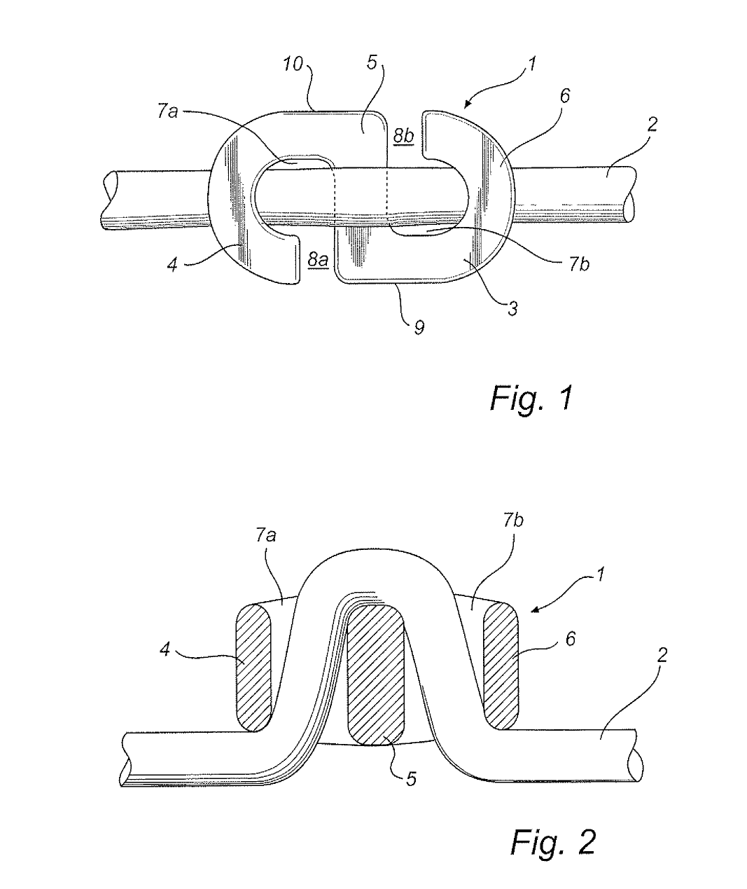

In FIGS. 1 and 2 a resilient element 1 being shown, which is intended to be applied on a rope or a corresponding elongated and flexible tension element 2, e.g. a wire, a chain or a cable. The resilient element 1 comprising an elongated body 3 of rubber or other elastic material, which in one first embodiment having at least one essentially S-shaped design, comprising a centrally located leg 5 and a leg 4 and 6, respectively, at each end, each partly surrounding a space 7a and 7b to which the tension element 2 is intended to be brought through a first opening 8a on one side 9 of the resilient element 1 and a corresponding second opening 8b on an other side 10 of the resilient element 1.

The tension element 2 will thus run below the first leg 4 up through the first space 7a and over the centrally located second leg 5 and thereafter down through the second space 7b and below the third leg 6. The dimension of the legs contribute to the features of the resilient element and at tension of the tension element 2 this will try to straighten itself, wherein the legs 4 and 6 being pressed in opposite directions towards the centrally located leg 5. The resilient element 1 will thus admit an additional stretching opposite to a spring force in addition to a possible stretching of the tension element 2 at applying a tension force in the tension element 2. As appear from FIG. 2, the centrally located leg 5 is preferably stronger dimensioned than the legs 4 and 6. The dimension of the legs 4 and 6 is chosen such that their height give a suitable spring force at tension in the tension element 2 simultaneously as their width are chosen such that the opening 8a and 8b can be sufficiently enlarged to bring in tension elements of different dimension.

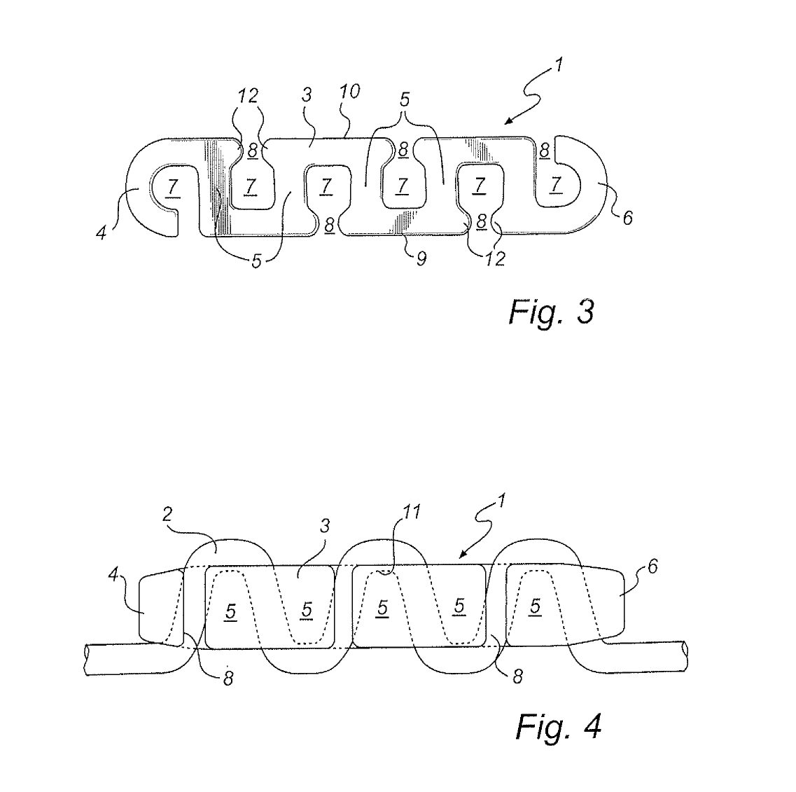

In FIGS. 3 and 4 an alternately formed resilient element 1 being shown comprising an elongated body 3 of an elastic material, through which a rope or a corresponding elongated and flexible tension element 2, as appear from FIG. 4, winds undulating, wherein a spring force being generate by said body 3 at stretching of said undulation when applying a tension force in the tension element 2. Said body 3 having several after each other S-shaped portions with several essentially transverse centrally located legs 5, in which two adjacent legs are alternately joined with each other at one side 9 and 10, respectively, of the elongated body 3 and having an opening 8 at the other side 10 and 9, respectively, of the elongated body 3, wherein the tension element 2 is intended to be introduced through said opening 8 and alternately undulates over and below, respectively, adjacent leg 5. I.e. each other space 7 between two legs 5 having an opening 8 towards the side 9 and remaining spaces 7 between two legs 5 having an opening 8 towards the side 10. Preferably, the central legs 5 of the resilient element may contain a depression 11, in which the tension element 2 is intended to bear on to fixate it. Preferably, at least one projection 12 also exist to provide a contraction of the opening 8 and preferably projections 12 are located on each side of the opening 8 to reduce the risk that the tension element 2 slide out through the opening 8 at use of the resilient element.

1. Resilient element comprising an elongated body of an elastic material through which a rope or a corresponding elongated and flexible tension element winds undulating, wherein a spring force being generated by said body at stretching of said undulation when applying a tension force in the tension element, wherein said body having at least one S-shaped portion with at least three essentially transverse legs, in which two adjacent legs alternately are joined with each other at one side of the elongated body and having an opening at the other side of the elongated body, wherein the tension element is intended to be introduced through said opening and undulates alternately over and below, respectively, adjacent legs.

2. Device according to claim 1, wherein the resilient element comprising several after each other S-shaped portions.

3. Device according to claim 2, wherein at least one centrally located leg comprising a depression, in which the tension element is intended to bear on.

4. Device according to claim 3, wherein at least one projection is arranged at the opening to provide a contraction of the opening.

5. Device according to claim 4, wherein projections are located on each side of the opening.
